(19) United States
(12) Patent Application Publication
(10) Pub. No.: US 2004/0156161 A1
(43) Pub. Date: Aug. 12, 2004

(54) Electromagnetic actuation

(76) Inventors: Ivor R Smith, Loughborough (GB); Bucur M Novac, Loughborough (GB)

Correspondence Address: Nixon & Vanderhye, 8th Floor, 1100 North Glebe Road, Arlington, VA, 22201-4714, US

(21) Appl. No.: 10/472,576

(22) PCT Filed: Mar. 14, 2002
(86) PCT No.: PCT/GB02/01165

(30) Foreign Application Priority Data
Mar. 27, 2001 (GB) 0107555.5

(51) Int. Cl. H01H 47/00

(52) U.S. Cl. 361/143

(57) ABSTRACT

A method and apparatus for imparting a repulsive force to a metallic component by way of a magnetic field induced in a drive coil placed at a distance from the component and separated by a metallic or non-metallic shield in which the magnetic field is built up rapidly to a peak value and then forced to decay slowly to enable the penetration of the magnetic field through the shield to act directly on the component in which elelctrical currents are induced.

This invention relates to electromagnetic actuation and, in particular, to methods and apparatus for exerting force on a metallic component by means of a remotely-generated electromagnetic field.

Our earlier International Patent Application, No PCT/GB99/02759 (published as WO 00/11351), describes various fastening arrangements in situations where it is required to connect two items together and where there is access to only one side of the assembly. In the arrangements described, a closure element formed of a ferro-magnetic material is urged into or out of mechanical engagement with a retention element, thus creating the fastening, by the application of an external magnetic field. Unfortunately, there is no description of how such a magnetic field might be generated. Moreover, there is no suggestion as to how such a magnetic field might be made to act through an intervening substance such as an aircraft skin panel.

In one aspect the present invention provides a method of exerting a repulsive force on a metallic component comprising generating a magnetic field in a drive coil located adjacent but not contiguous to the component and such that any magnetic field generated in the drive coil is directed towards the component, the magnetic field being generated by rapidly building a current in the drive coil to a maximum value and ensuring the current decays slowly from the maximum value with no reversal of current flow, such that a magnetic flux is induced in the coil which flux rapidly reaches a maximum value and decays slowly therefrom with no reversal of polarity.

Such an arrangement has proved capable not only of exerting a force on the component, and of moving a copper ring weighing 8.5 g with a maximum velocity of 30 m/s, but also of exerting this force despite the presence of an intervening plate of a solid material. Most surprisingly, it has been shown that this effect can be reproduced even when the intervening material is itself metallic. Demonstration of the diffusion of the magnetic field through a relatively thick metallic shield using the techniques of the present invention supports the theoretical prediction that the invention enables the remote electromagnetic repulsion of metallic components through an intervening shield formed of a conducting or ferro-magnetic material of virtually any thickness, and so permits such repulsion even through the walls of a Faraday cage. Those skilled in the art will immediately appreciate the potential benefit of this invention, and its use in applications significantly removed from fasteners, to any application where remote actuation through an intervening, possibly metallic, material could be desirable such as in the chemical processing or nuclear power industries, for example.

The current in the drive coil is suitably built to its maximum value in not less than 5 μs and not more than 20 μs. The current in the drive coil then preferably decays with a time constant of at least 1 ms, and preferably more than 2 ms. It has been found that such a current build up and decay profile, in which the current rises very quickly and then decays very slowly, produces a similar profile of induced magnetic field which will penetrate though an intervening material to induce a similar though somewhat attenuated current in the component sufficient to impart a repulsive force and movement thereto.

Such a current profile is preferably generated by discharging a capacitor or a bank of capacitors through a ballast inductor and the drive coil, and crowbarring the circuit, so as to separate the ballast inductor and the drive coil from the capacitor, once the current in the drive coil reaches its first peak value (in the order of at least 70-100 k A) using a crowbar switch of low resistance design. The repulsive force is experienced by a metallic component, suitably in the form of a ring, and preferably equivalent to or incorporating a coil, which is separated from the drive coil by at least one air gap, and advantageously, a plate or shield of a solid material (or a “specimen”).

In a second aspect the invention provides an apparatus for exerting a repulsive force on a metallic component, the apparatus comprising an electrical circuit containing a capacitor (or capacitor bank), a ballast inductor, a closing switch and a drive coil, a crowbar switch being provided to separate the circuit into two parts, one containing the capacitor and the closing switch and the other containing the ballast inductor and the drive coil.

The combined resistance of the ballast inductor and the drive coil is preferably less than 300 μ Ω with the ballast inductor preferably having an inductance of about 400 n H (since a greater value would reduce the current from the capacitor below the required level, and a lower value would make the resistance too low to enable the extended decay time to be achieved).

Preferably the resistance of the crowbar switch is less than 150 μ Ω, preferably about 100 μ Ω, and it should also have a closure time of not more than 20 μs, with a jitter time of less than 100 n s (“closure time” is the time between starting the capacitor bank and full closure of the switch).

The invention will now be described by way of example and with reference to the accompanying drawings, in which:

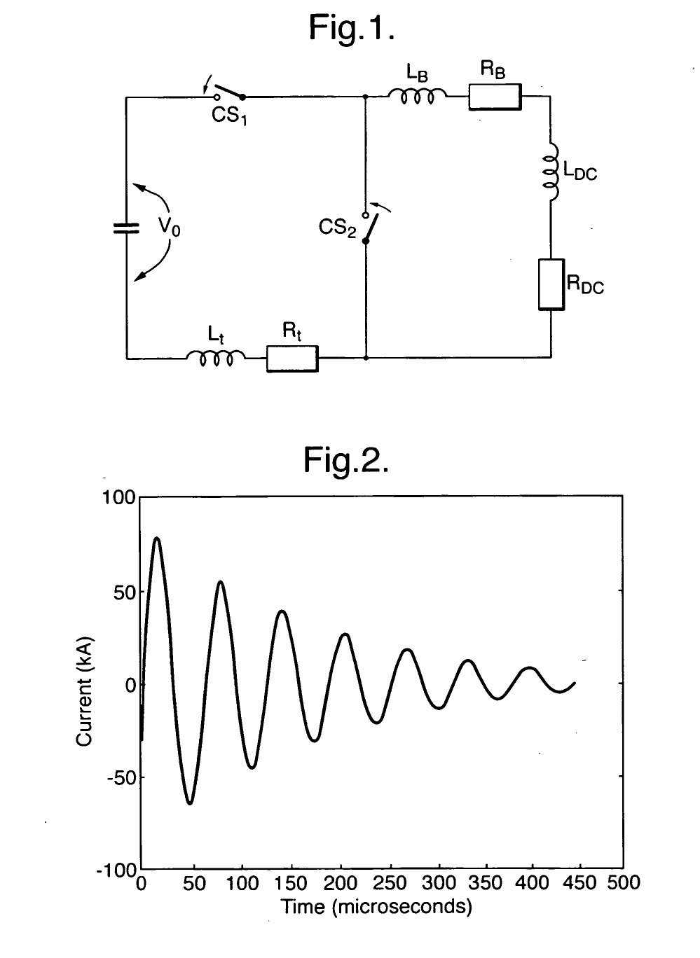

FIG. 1 is a schematic drawing of an electric circuit equivalent to that of the apparatus of the present invention;

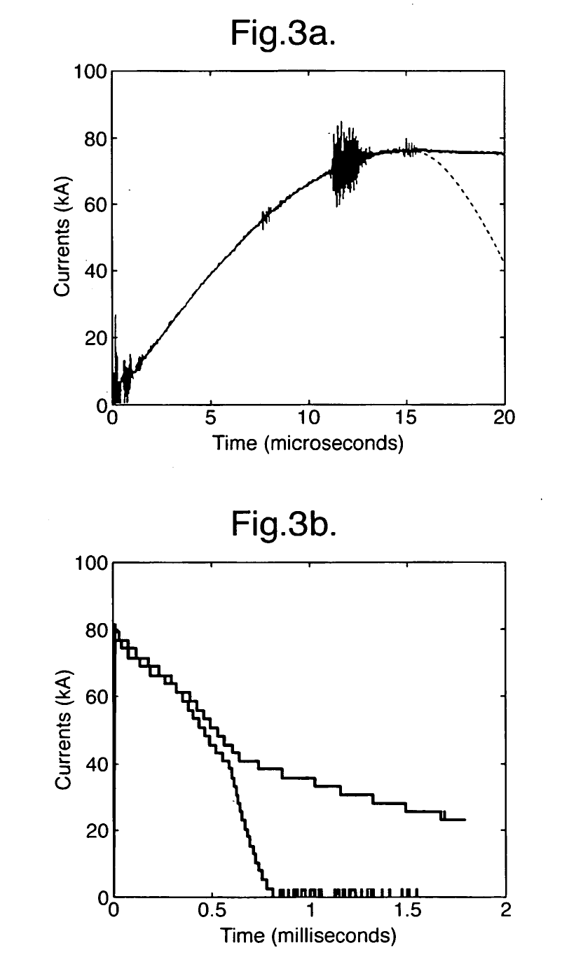

FIG. 2 is a graphical depiction of the electrical current in the drive coil of FIG. 1 when the capacitor is discharged and the crowbar switch not operated;

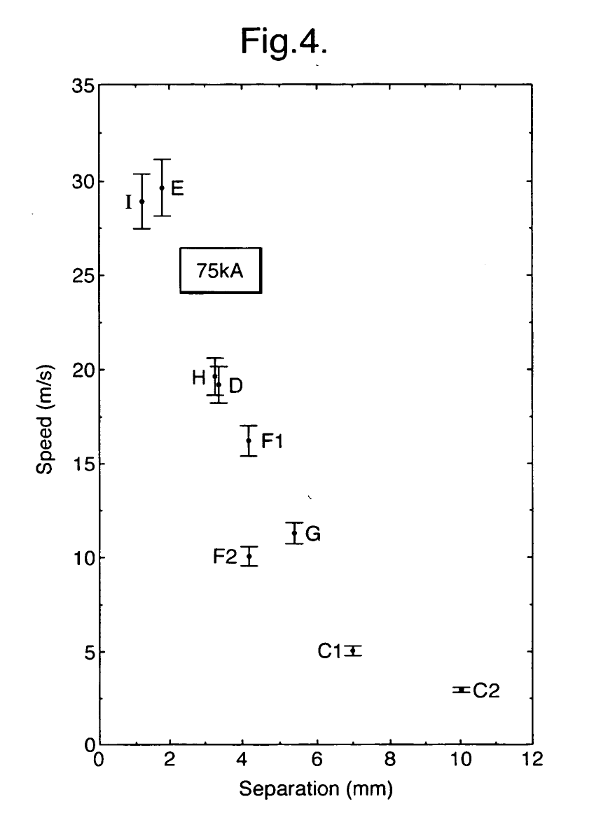

FIGS. 3a and 3b illustrates the effect on the drive coil current shown in FIG. 2 of operating the crowbar switch when the current reaches the peak current value;

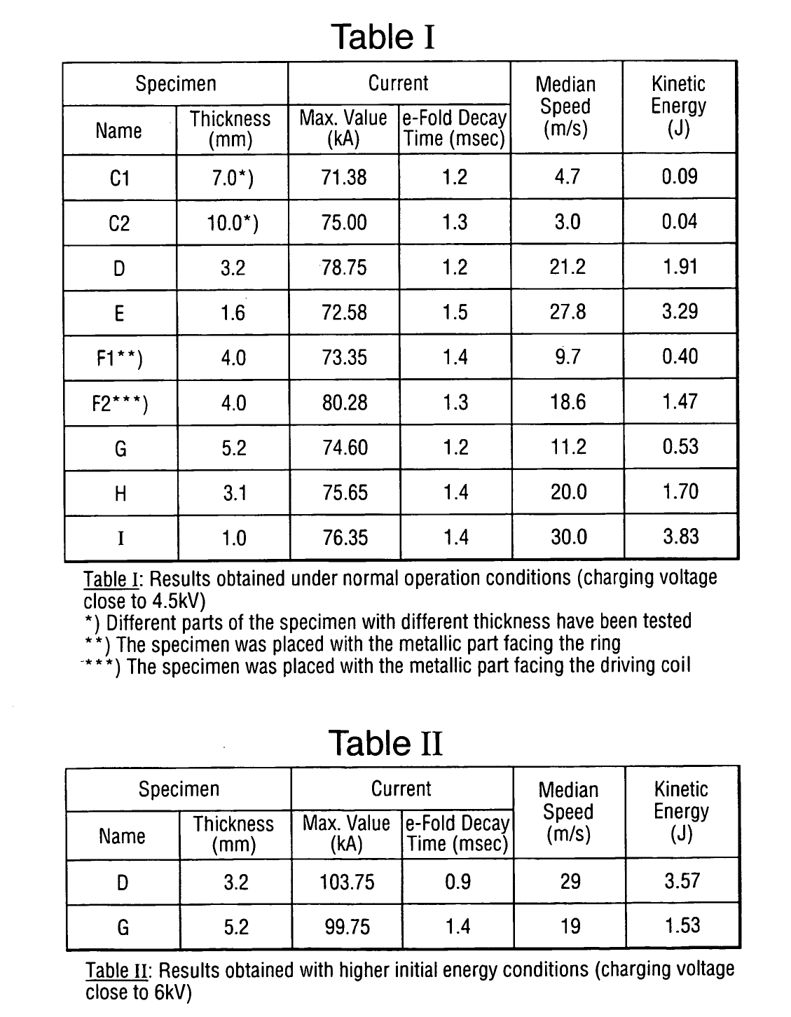

FIG. 4 is a graphical display of the results of experiments also summarised in Tables I and II showing the velocity induced in a copper ring against its separation from the drive coil, with various sheets of material of differing thicknesses and compositions interposed, when a maximum drive current of 75 kA is applied (in table I; in table II the maximum drive current is approximately 100 kA, the charge voltage being approximately 4.5 kV (Table I) and approximately 6 kV (Table II), and

In the apparatus of FIG. 1 a capacitor of approximately 200 μ F is initially charged to a voltage Vo of between approximately 4.5 kV and 6 kV (so as to induce a maximum driving current of 75 kA+ or −5 kA) or 100 kV+ or −5 kV and is discharged on closure of a switch CS₁ through a ballast inductor (having resistance R_{b} of less than 100 μ Ω and inductance L_{b} of about 400 nH) and a drive coil (having resistance R_{DC} and inductance L_{DC}). The circuit comprises a transmission line, which has an equivalent inductance Lₜ of about 100 n H and a resistance of Rₜ.

Discharge of the capacitor in the circuit of FIG. 1 by closing switch CS₁induces maximum current of about 75 kA in the circuit, the current building up sinusoidally, as shown in FIG. 2, to a peak which then decays in a sinusoidally oscillating fashion in the absence of a crowbar switch (in such a case, experiments show that no force is exerted on a metallic object where there is an intervening metallic specimen). When the current reaches its first peak value, a crowbar switch CS₂ is closed, causing the current to decay slowly from its peak value without any reversal in polarity, as shown in FIG. 3a (note the electromagnetic noise produced when the crowbar switch operates, followed by a smaller amount of noise as the switch closes precisely at the peak current). FIG. 3b shows the long delay phase. The top curve is the normal driving coil current, maintained at 25% of the peak value even after 2 ms. The lower curve is the current when the driving coil explodes, introducing a very high resistance into the circuit, but only after 0.5 ms.

The design of the crowbar switch is very important, in order to produce a decay time of more than 2 ms (the time for the current to build to its peak being about 7.5 μs). It requires a very slow resistance switch to crowbar the circuit of FIG. 1 into two parts: the capacitor bank and transmission line, where the main closing switch is located, and the ballast inductor and driving coil. Closure of the crowbar switch needs to be 7.5 μs after that of the main closing switch, when the current in the ballast inductor is at a maximum, and the switch CS₂ must have the following characteristics:

(i) Before closure, it must withstand the voltage spike produced as the capacitor bank begins to discharge. The spike results from the impedance mismatch between the parallel-plate transmission line and the ballast inductor, and could reach almost twice the capacitor charging voltage.

(ii) It must operate with a jitter of less than 100 ns.

(iii) It must close successfully, even when the voltage across the switch is not more than a few hundred volts.

(iv) After closure, it must withstand a current of at least 100 kA, decaying exponentially with a time constant of 2 m/s. The maximum value of rate-of-change of current could be −5×10⁷ A/s.

(v) The resistance introduced into the circuit must be about 100 μΩ.

In the examples shown in tables I and II a detonator actuated switch was used; although reliable and simple, such switches are not capable of repetitive use, and for a repetitive system either thyristors or thyratrons would be used.

In the examples referred to in Tables I and II and depicted in FIG. 4, an 8.5 g copper ring was placed at different separation distances from the drive coil with a variety of specimens, or sheets of material, interposed, and the maximum velocity, away from the drive coil achieved by the ring measured when the capacitor had been discharged and the crowbar switch CS₂ closed.

The copper ring weighing 8.5 g, and having the same radial and axial dimensions as the drive coil (outer/inner diameters 21.8/14 mm, height 4.3 mm), was placed above the specimen (sheet material) and on the same axis. It was separated from the specimen by 25 μm of Mylar, giving the initial separation between the driving coil and the ring as the specimen thickness plus 0.2 mm comprising the different layers of insulation and some residual air.

The quality of the closing switch contact is given in Table I as the e-fold time decay. The median speed represents a value obtained from all the velocity measurements available for that experiment. Specimen C had a triangular profile, and was tested at two different positions. Two different tests detailed in Table I were necessary for specimen F, as this consists of a metallic layer glued to an insulating layer.

It should be noted that in FIG. 4 the distance along the x axis is the initial separation between the driving coil and the ring (i.e. not the specimen thickness). In addition, the velocity on the y axis is adjusted to the 75 kA value by multiplying by the square of the ratio of 75 kA to the actual maximum current. The results in this figure suggest strongly that it is possible to draw a 75 kA curve that fits closely to all the results obtained. In particular, the metal specimens (such as F and I) fit this curve just as well as do the non-metallic specimens (such as G). It will also be noted from FIG. 4 that in the case of specimen F the highest velocity was obtained when the metal layer was nearest to the driving coil (compare experiments F1 and F2).

As can be seen from FIG. 4 and the tables, seven specimens were tested, with the power source energised to 4.5 kV to give a peak driving current of about 75 kA. After crowbarring, the current in the drive coil decayed with a time constant of 1.4 ms. All experiments performed were successful, with the velocity imparted to the ring away from the specimen depending on the thickness of the specimen (from 1 mm to 10 mm) and being measured at between 3 m/s and 30 m/s. An empirical relationship between the ring velocity and the initial separation of the ring and the drive coil, indicates that the ring is moved with a velocity that has little dependence on whether or not the specimen material is metallic or non-metallic. The success of the experiments at 75 kA suggested that it was unnecessary to undertake further experiments at higher currents. Nevertheless, two experiments at 100 kA (see Table II) showed that the action on the ring is indeed scalable with the driving current, as suggested by theory.

Comparative experiments in which the initial separation was an aluminium/air composite demonstrated without doubt that any possible mechanical interaction with the ring plays only a minor role in the acceleration process (through shock waves). The ring could be moved with a speed of 15 m/s, even when the aluminium thickness was about 3 mm.

The graph at FIG. 4 illustrates that electromagnetic actuation is possible even through an intervening metallic specimen, or layer, of 12 mm thickness; theoretical calculations indicate that similar actuation can be effected through any thickness of intervening specimen, and that such actuation will remain effective despite attenuation provided the initial maximum current value is increased.

A further possibility considered was whether the projectile acceleration was assisted by shock waves generated by either the driving coil or the shield and transmitted through air. To investigate this a third series of experiments was performed with the crowbar switch CS₂ removed from the circuit, so that the drive coil current was of a damped sinusoidal form. With the projectile again mounted on the plastic platform and with the same aluminium shields as before, discharge of the capacitor did not result in the projectile being launched, although on a TV monitor a small disturbance was evident. The experiments clearly demonstrated that the crowbar switch is necessary for a successful launch and that, even if present, shock waves do not play an important role.

It has therefore been successfully shown that a drive coil can repel a ring on the remote side of a conducting plate (the specimen). Those skilled in the art will appreciate that there are many possible applications of this invention, apart from the fastening arrangement disclosed in PCT/GB99/02759 (WO 00/11351)

1. A method of exerting a repulsive force on a metallic component comprising generating a magnetic field in a drive coil located adjacent but not contiguous to the component and such that any magnetic field generated in the drive coil is directed towards the component, the magnetic field being generated by rapidly building a current in the drive coil to a maximum value and ensuring the current decays slowly from the maximum value with no reversal of current flow, such that a magnetic flux is induced in the coil which flux rapidly reaches a maximum value and decays slowly therefrom with no reversal of polarity.

2. A method according to claim 1 wherein the component is separated from the drive coil by a layer of a conducting material.

3. A method according to claim 1 or 2 wherein the current in the drive coil is built to its maximum value in not more than 20 μs.

4. A method according to claim 1, 2 or 3 wherein the current decays with a time constant of at least 1 ms.

5. A method according to any preceding claim wherein the current fed to the coil is produced by discharging a capacitor through a ballast inductor.

6. A method according to claim 5 wherein the current is caused to decay by crowbarring the capacitor and the ballast inductor.

7. A method according to any preceding claim where the component is equivalent or includes a coil.

8. Apparatus for effecting the method of claim 1 comprising a circuit containing a capacitor, a ballast inductor, a closing switch and the drive coil, a crowbar switch being provided to separate the circuit into two parts, one part containing the capacitor and the closing switch and the other part containing the ballast inductor and the drive coil.

9. Apparatus for exerting a repulsive force on a metallic component through an intervening layer of a conducting material, the apparatus comprising a circuit containing a capacitor, a ballast inductor, a closing switch and the drive coil, a crowbar switch being provided to separate the circuit into two parts, one part containing the capacitor and the closing switch and the other part containing the ballast inductor and the drive coil.

10. Apparatus according to claim 8 or 9 wherein the combined resistance of the ballast inductor and the crowbar switch is less than 300 μ Ω.

11. Apparatus according to claim 8, 9 or 10 wherein the resistance of the crowbar switch is less than 150 μ Ω.

12. Apparatus according to any of claims 8 to 11 wherein the crowbar switch has a closure time of less than 20 μ s, with a jitter time of less than 100 n s.
